(19) United States
(12) Patent Application Publication
(10) Pub. No.: US 2002/0188801 A1
(43) Pub. Date: Dec. 12, 2002

(54) Method and apparatus for dynamically controlling a caching system

(75) Inventor: Henry J. Green, Blacksburg, VA (US)

Correspondence Address: FLEHR HOHBACH TEST ALBRITTON & HERBERT LLP, Suite 3400, Four Embarcadero Center, San Francisco, CA, 94111-4187, US

(73) Assignee: Intransa, Inc., a Delaware Corporation, Sunnyvale, CA

(21) Appl. No.: 10/113,535

(22) Filed: Mar. 29, 2002

Related U.S. Application Data
(60) Provisional application No. 60/280,588, filed on Mar. 30, 2001.

(51) Int. Cl. G06F 12/00

(52) U.S. Cl. 711/113; 711/142; 711/143

(57) ABSTRACT

A data storage system and method to promote integrity of data written, optionally using a cache with buffer to persistent memory. Health of a computer system is dynamically monitored. If good health is present, during a data write operation, the cache system is configured so data is buffered within the cache, thus promoting faster performance. But if good health is absent, the cache system is configured to write through to persistent memory, thus trading off speed for integrity of the data stored. Optionally, a multi-level cache hierarchy system can be used as the caching system.

RELATION TO CO-PENDING APPLICATION

This application claims priority to co-pending U.S. Provisional Patent Application No. 60/280,588, entitled, “Virtual Storage Network,” filed Mar. 30, 2001, David C. Lee et al. inventors, which is incorporated herein by reference.

### FIELD OF THE INVENTION

The present invention relates to the field of caching write requests and more specifically to dynamically configuring a caching system based a diagnostic analysis of relative health.

### BACKGROUND OF THE INVENTION

Devices for storing information or data in memory are known in the art, e.g., magnetic storage, optical storage, solid state storage. Memory may include persistent storage, non-volatile storage, or volatile storage. Typically information is presented to such storage devices and memory using a known protocol or format. Normally a computer system will write data to a storage device, using a write request. After the write request is made the reliable computer system waits for an acknowledgment that the write request was successfully completed. Because a storage device is generally much slower than a computer system, a caching system, which is relatively faster than persistent storage, may be used by the computer system to acknowledge that the write request was successful. Unfortunately, if the computer system fails then the data actually stored may be corrupted because the caching system has acknowledged the write request before the write request has been performed. Stated differently, the caching system acknowledges that the write request was successfully completed even though the data associated with the write request (e.g. a file) has not actually been stored to a persistent storage device (e.g., a disk drive).

Caching improves the overall performance because the computer system is allowed to continue working on something else instead of waiting for a write request acknowledgment, but unfortunately reduces overall reliability of the computer system. As noted, reliability can suffer because the data associated with the write request is normally stored in a buffer associated with cache or a volatile memory that can lose the buffer contents if there is a computer failure or if the power is accidently lost. Consequently, a tradeoff between performance and reliability is required to determine if buffering contents of a write request is appropriate.

Adding to the complexity, multiple levels of caching may be used. The write request from the computer may include utilizing an operating system cache and a disk controller cache before the data to be stored actually reaches a persistent storage system such as the physical disk in a disk drive. The operating system cache may represent the highest level caching system, while the disk controller cache may represent the lowest level caching system. Each level of caching systems may be independently configurable. Typically the configurations allow support for caching data, caching data and acknowledging that the write request has been performed successfully, and simply pass the data through to the next level of caching.

Buffering data in a multiple level caching system may also include an acknowledgment of the buffering to computer system. For example, the first time the contents of a write request is buffered at a level in a multiple level caching system, the caching system may generate an acknowledgment that the write request was successfully completed. The acknowledgment of subsequent buffering of the same data at other levels in the multiple level caching system may not be required because the computer system has already been sent an acknowledgment that the write request was successfully completed.

Caching data prior to the actual completion of a write request enhances computer performance but does reduce the reliability of actually storing the data into a persistent storage device or memory. Correspondingly, caching data in the highest level caching system provides the greatest improvement in performance because the data to be written can be easily handed off to the caching system closest to the computer system. Alternatively, caching data in the lowest level caching system provides some improved performance, and a much higher reliability because this caching system is closer to the persistent memory. If a power failure did occur, the lowest level caching system may still be capable of saving the data to the persistent memory, whereas the highest level caching system may not.

Diagnostic systems can determine the relative health of a computer system, and indeed some components in a computer system can even perform self-diagnostics. Such diagnostic systems can warn of likely or imminent failures. For example, a battery backup system can monitor the main power provided to the battery backup system. Such health consideration can be very important, and good health can warrant caching to improve performance. On the other hand, poor health suggest that reliability may be much more important than performance. Caching and poor health (e.g. battery backup failure) can result in data corruption where only a part of the data is actually stored. Recall that the computer system would have received an acknowledgment of the successful write request, however, with caching the actual storage of the data to a persistent memory may not have actually occurred.

A battery backup system is a good source of information for determining the health of a computer system. If the main power is lost then the battery backup system can so indicate. The battery backup system may be able to power the computer system for a minimal amount of time before power the computer system is lost. Correspondingly, if the power is lost, the computer system health is poor, and when the power is returned, the computer system health may be good. Another exemplary diagnostic system is included with some disk drives that include a SMART feature, which can predict an imminent failure of a disk drive approximately 60 percent of the time.

Configuring a caching system can be complicated. Typically, the caching system is configured when an operating system for the computer is installed. The user may also be allowed to configure caching of a computer system based on a tradeoff between performance and reliability. However, once the configuration is made, the configuration is somewhat static, and is typically used until changed again by the user. Unfortunately, this static configuration of the caching system fails to take into consideration information available from diagnostic systems. Changing caching configuration according to the prior art typically requires the computer system to be shut down in a specific manner, reconfigured, and restarted. During this process the computer system is inaccessible to users and potential client systems.

FIG. 1 depicts configuring a caching system according to the prior art, and includes a computer system 100, a caching system 110, and a persistent memory system 120, which may be defined as a non-volatile memory, e.g., a physical disk platter. Manual configuration is required to define the caching process and a user may configure the cache state 130 and the memory state 140 using the computer system. Typically an acknowledgment is received with each write request 150 of the computer system, and in FIG. 1, the acknowledgment (ack) may be a cache ack 160, or a memory ack 170. Typically if the computer system 100 does not receive an ack it is assumed the write failed and the computer system would perform the write request 150 again.

Caching systems may include at least two states, including a buffer-ack state 180 in which data of a data write request is buffered and a cache acknowledgment signal (C-ACK) is generated to acknowledge buffering of data, and a write-through-buffer-noack state 190 in which contents of the data write request is buffered. Optionally, a write-through-nobuffer-noack state 200 may be provided in which the data of a data write request is not buffered or acknowledged but passed though the cache.

Persistent memory system 120 typically receives and stores the contents of the data write request. The persistent memory system typically includes at least two states including a memory-ack state in which the data is stored and a memory acknowledgment signal (M-ACK) is generated to acknowledge storing of the data, and a memory-noack state in which the data is stored without an acknowledgment.

The user, system administrator, or an operating system installation process manually configures 220 the caching system 110 and the persistent memory system 120. Typically the caching process is manually configured 220 one time and left in a static state. As depicted in FIG. 1, the status of the battery backup system 230, and the internal sensor 240 do not provide any interaction with the manual configuration 220.

FIG. 2 depicts the process of reconfiguring the prior art caching system with respect to imminently foreseeable power failure as indicated by the battery backup system. Prior to the power failure the caching system was configured according to a buffer-ack state 180, to improve performance of the computer system. After the power failure the caching system has not been reconfigured. Unfortunately, the computer system is still configured to enhance performance, in disregard of the imminently foreseeable power failure. Optionally, the user could attempt to manually reconfigure 220 the caching system to maintain integrity of data. But the computer system 100 may be shutdown, due to a lack of power, before the user has manually reconfigured the caching system 110.

Note that the integrity of the data may be compromised because data associated with the write request 150 may still reside in the caching system 110. Here the caching system was configured according to a buffer-ack state 180 in which data of a data write request is buffered and a cache acknowledgment signal (C-ACK) is generated to acknowledge buffering of data. Therefore, the computer system 100 has received an acknowledgment of a successful write and may assume the data included in the write request 150 was actually written to a persistent memory system 120. But, in fact the data currently resides in a buffer associated with the caching system 110. Consequently, the actual data stored in the persistent memory system 120 will be inconsistent.

Thus, there is a need for a dynamic cache control system and a method for updating the cache control system based on diagnostic information available from diagnostic systems associated with the system. Health of the computer system changes dynamically and should be taken into consideration dynamically when evaluating the tradeoffs between enhancing performance and ensuring reliability of a computer system. In controlling the caching system, such system and method should efficiently utilize information available from diagnostic systems, diagnostic components, user preferences, and the caching configuration.

The present invention provides such a dynamic cache control device and method.

### SUMMARY OF THE INVENTION

The present invention provides a data storage system and method to maintain integrity of data written to a persistent memory system. A computer system performs a data write request via a caching system to the persistent memory system. A diagnostic analysis determines dynamically if the computer system will support buffering of data in the caching system without loss of integrity. If buffering can be performed without loss of integrity (e.g., good health) then the caching system is configured to buffer the data before subsequently writing data to a persistent memory system. If buffering cannot be performed without loss of integrity (e.g., bad health) then the caching system is configured to write the data through the caching system to the persistent memory system, optionally a multi-level cache hierarchy system can be used as the caching system.

Other features and advantages of the invention will appear from the following description in which the preferred embodiments have been set forth in detail, in conjunction with the accompanying drawings.

### BRIEF DESCRIPTION OF THE FIGURES

FIG. 1 generally depicts a caching system, according to the prior art;

FIG. 2 generally depicts a caching system with an imminent system failure, according to the prior art;

FIG. 3 generally depicts a dynamically configurable caching system, according to the present invention;

FIG. 4 depicts a dynamically configurable caching system with an imminent system failure, according to the present invention;

FIG. 5 depicts a dynamically configurable caching system with a multi-level-cache hierarchy, according to the present invention;

FIG. 6 depicts a process of dynamically configuring a caching system, according to the present invention.

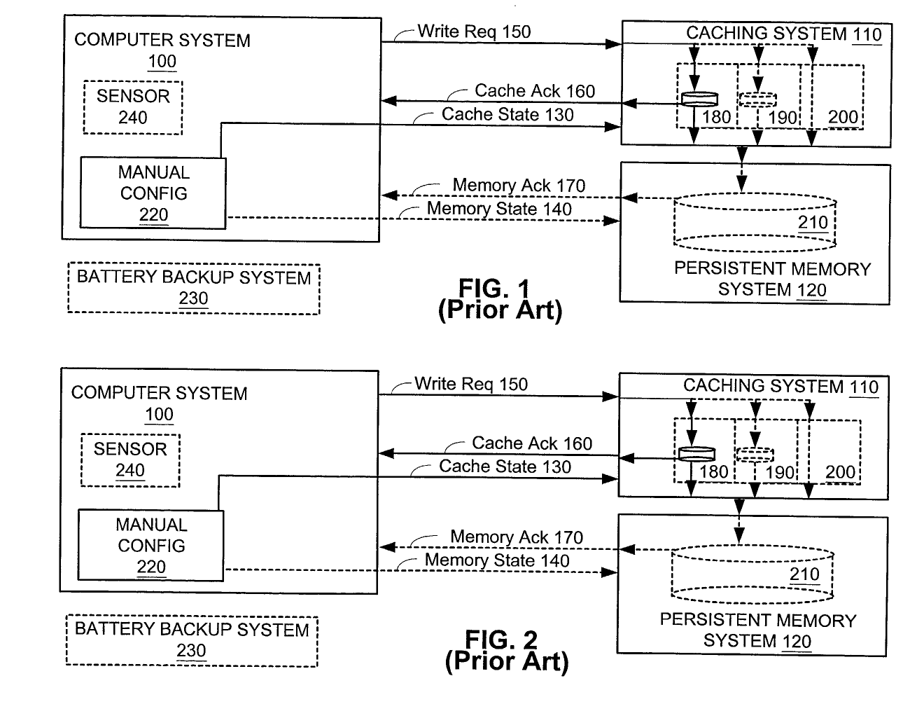

### DESCRIPTION OF THE INVENTION

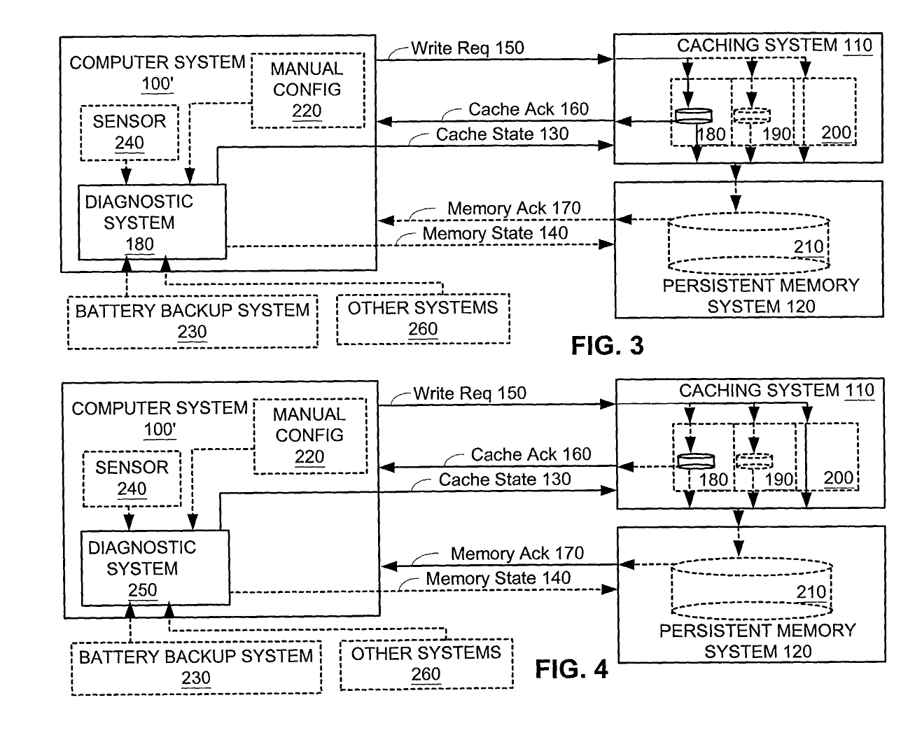

The present invention provides a method and apparatus for dynamically configuring a caching system. FIG. 3 generally depicts a dynamically configurable caching system of an improved computer system 100′, according to an embodiment of the present invention. A diagnostic system 250 is added to facilitate maintaining the integrity of data written to a persistent memory system 120. The diagnostic system 250 can be configured to interact with and to receive information from other systems associated with the computer system 100′. As shown, the diagnostic system 250 is preferably coupled with a battery backup system 200, an internal sensor 240, the manual configuration 220, and with other systems 260. The diagnostic system 250 may be capable of predicting when a failure will occur, if a failure has occurred, and may reconfiguring the caching system, thereby helping to maintain the integrity of the computer system.

FIG. 4 depicts a potential response by the dynamically configurable caching system to an imminently foreseeable system failure, according to the present invention. Whereas the FIG. 2. prior art system ignored signs of an imminent system failure, the improved computer system 100′ dynamically can examine information concerning an imminent system failure and preserve the integrity of data written to persistent memory. The present invention may receive information indicating a power failure (as an example of bad health) as indicated by the battery backup system 230, and respond by reconfiguring the caching system.

Prior to the power failure or other onset of bad health, the caching system may be configured according to a buffer-ack state 180, to improve performance, as described above. After the occurrence of the power failure the battery backup system 230 notifies the diagnostic system 250 of the power failure. The diagnostic system 250 may then take steps to reconfigure the caching system or the memory system to help maintain integrity of data in a write request 150. More specifically, the diagnostic system can configure the caching system 110 to a write-through-buffer-noack state in which data may be buffered but Ack is not sent until persistent memory is written in the caching system. Either Write-through state may allow the caching system to take advantage of cached reads. Potential corruption of the data is reduced because the information will be written through to persistent memory.

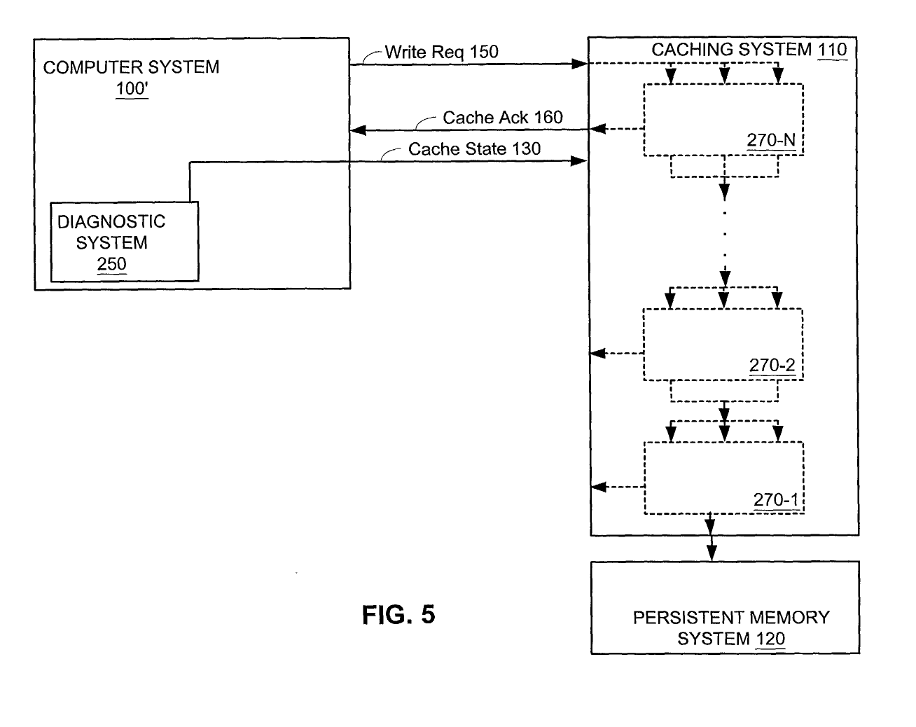

FIG. 5 depicts a dynamically configurable multi-level-cache hierarchy that typically includes multiple caching levels, according to the present invention. Preferably independent of the organization of individual sub-caching systems (or caching levels) 270-1, 270-2, . . . , 270-N, within the caching system 110, the diagnostic system may change the caching state of at least one of the caching levels. Each caching level may perform a caching function based on a set of states. The number and/or function of each individual caching level may vary, including support for different states.

As such, several caching levels may be disposed between the computer system 100′ and the persistent memory system 120. Typically each write operation must be acknowledged and if a data write is lost or incomplete, the computer system may retransmit the write request. Acknowledgments from a caching systems can be performed to enhance performance since the persistent memory system is typically much slower than the caching system 110. As noted, acknowledgment of a write request 150 from the highest level sub-caching system 270-N offers better performance but less reliability in the case of a system or media failure. Acknowledgment of a write request 150 from a lower level sub-caching system 270-2 offers poorer performance but greater reliability. Acknowledgment of a write request 150 from the persistent memory system 120 offers the poorest performance but the highest reliability. Consequently, a tradeoff between performance and reliability is performed, preferably dynamically, in selecting the origin of the acknowledgment.

Depending on such tradeoff, each caching layer of the caching system 110 is typically designated as at least write-back or write-through. For better reliability, the highest sub-caching level 270-N may be set to write-through, and the lowest sub-caching level 270-1 may be set to write-back. Dynamic configuration based on the diagnostic system 250 facilitates taking the current health of the computer system into consideration in analyzing the tradeoffs between performance and reliability. Consequently, the computer system would tend to have the highest performance while being the most reliable with a minimal risk of data corruption.

The diagnostic system may periodically reconfigure one or more of the caching levels. Alternatively, the diagnostic system may reconfigure of one or more caching levels based on the occurrence of an event, such as an alarm. An event may be associated with either the computer system 100′, an some external system coupled with the computer system 100′ such as a battery backup system 230 or other system 260.

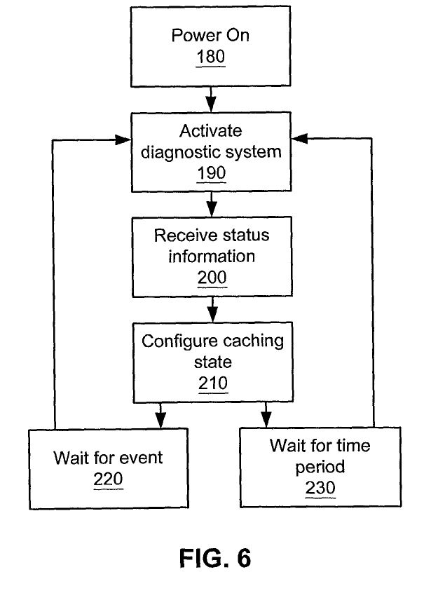

FIG. 6 depicts a process of configuring a caching system, according to one embodiment. Initially, power to the computer system is turned on 180. As part of the power up sequence the diagnostic system may be activated 190. Status information may be received 200 from other system associated with the computer system. Status information may include manual configuration, sensors, battery backup system, and other systems. Based on the information received, the diagnostic system may configure the caching state 210, potentially including the state of a number of sub-caching levels 270-1, . . . , 270-N, and the persistent memory system 120. Subsequently, the process may wait for the occurrence of an event 220, such as a power failure as indicated by a battery backup system. Additionally, the process may reactivate the diagnostic system at a specific interval 230, such as every 60 seconds.

According to one embodiment, a diagnostic analysis is performed to determine if the computer system will support buffering data in the caching system without loss of integrity. The determination may include analyzing information indicating the health of the computer system, such as information from the battery backup system. If the health of the computer system will support buffering then the diagnostic system 250 may configure the caching system to buffer data before writing to a persistent memory system. Here, buffering will improve the performance of the computer system. If the health does not support buffering then configuring the caching system to acknowledge a write when the data is written to a persistent memory system, thereby improving the reliability of the computer system. The diagnostic analysis may include performing diagnostic analysis of any systems coupled with the computer system including any persistent memory, ATA hard disk with SMART, battery backup, operating system, and ambient internal temperature.

The diagnostic system 250 may perform a diagnostic analysis to determine the health of the computer system. Alternatively, another system coupled with the computer system may provide the result of a diagnostic analysis to the diagnostic system 250. The diagnostic system may use information associated with the diagnostic analysis to configure the caching system and the memory system.

The diagnostic analysis may include a range of health for the computer system to determine whether the health of the computer system will or will not support buffering. The range of health may include a level of write confidence associated the level of buffering, for example a write confidence may be a numerical value from 0 to N. In such sequence 0 can indicate lowest confidence, such that a acknowledgment should be made from the persistent memory system, and N can be a number indicating highest confidence The value 0 may be used to indicate the acknowledgment should be made only after the data of a write request is actually written to a persistent memory. The value I may represent a slightly higher level of write confidence, such that only the cache closest to the persistent memory system should acknowledge the write request. The value N, represent a highest level of write confidence, such that the highest cache may acknowledge the write request. Correspondingly, the diagnostic analysis may be used to configure the caching system and the persistent memory system.

Flushing (e.g., transferring buffer contents into persistent storage) the caching system or a given buffer may be requested by the diagnostic system. Buffers may be configured to flush any contents of the buffer and write the contents of the buffer to a persistent memory system. If a failure of the computer system is imminently foreseeable then all information in a buffer may be stored to the persistent memory system to avoid loss or corruption of the data. The range of health may be used to determine if a given buffer in the caching system should be flushed.

The caching system may receive a data write request and handle the data according to the state of the caching system. In one embodiment, the caching system may be state-configurable and may have three different states. A write-through-buffer-noack state in which the data is buffered and no cache acknowledgment signal is generated. A buffer-ack state in which said data is buffered and a cache acknowledgment signal (C-ACK) is generated to acknowledge buffering of said data. A write-through-nobuffer-noack state may also be supported, which provides that data is passed through without buffering and without generating a cache acknowledgment signal.

The persistent memory system may receive a data write request and handle the data according to the state of the persistent memory system. In one embodiment, the persistent memory system may be state-configurable and may have at least two different states. A memory-ack state in which said data is stored and a memory acknowledgment signal (M-ACK) is generated to acknowledge storing of data. A memory-noack state in which data is stored without generating a memory acknowledgment signal.

The computer system may also perform a diagnostic analysis to determine if said computer system will support buffering data in a caching system without loss of integrity. Additionally, the computer system may dynamically configure the caching system and the memory system based on the diagnostic analysis performed. The dynamic configuration may include at least one of modifying cache state, and modifying memory system state.

In one embodiment the computer system can perform a data write request via a caching system to the persistent memory system. The diagnostic system can dynamically reconfigure the caching system and the persistent memory system as a function of the diagnostic analysis. Here, a successful data write request is signaled to the computer system by an acknowledgment signal. Initially, the computer system performs the data write request, and the caching system receives the data write request and handles the data according to the state of the caching system. The caching system performing a persistent data write request to store the data, and the persistent memory system receives and stores the data. The computer system may determine whether a C-ACK or M-ACK was received. if neither a C-ACK nor a M-ACK was received, the computer system re-sends the data write request. If one of the C-ACK and the M-ACK was received, then the computer system may assume the write was successful. In the present invention, a more aggressive assumption may normally be made (compared to a prior art system) due to dynamic health monitoring and dynamic cache system reconfiguring. The computer system may also perform a diagnostic analysis. Additionally, the computer system may dynamically configure the caching system and the memory system based on the diagnostic analysis performed.

In one embodiment an internal sensor 240 is coupled with the diagnostic system 250 to indicate whether the computer system is at a critical temperature level. The sensor may be coupled to a diagnostic system that can obtain information from a sensor to perform a diagnostic analysis. Information from the diagnostic analysis can be used to maintain the integrity of computer system 100′ by reconfiguring the caching system 10 and the persistent memory system 120 to minimize the impact of a potential failure on the integrity of data written by the computer system. Information from the diagnostic analysis can also be used to improve performance of the computer system 100′.

According to another embodiment, a caching system may include a multi-level cache hierarchy system and may include at least two cache levels including a highest level sub-caching system 270-N and a lowest level sub-caching system 270-1. The highest level caching system receives the data write request from the computer system. The lowest level caching system writes to said persistent memory system including at least the data included in the data write request. Generally, a higher level caching system may send a second write request including at least the data included in the data write request to an immediately lower level caching system, and a lower level caching system can receive the second write request from an immediately higher level cache. Additional levels may be added to the multi-level cache hierarchy system. Each of the individual caching system may be independently configurable.

Accordingly, in a multi-level caching system with two caching systems (a highest level and a lowest level) may handle a write request from a computer system as follows. The highest level caching system receives the write request from the computer system. By definition, the highest level caching system is also a higher level caching system than the lowest level caching system. Therefore, the highest level caching system may send a second write request including at least the data included in the data write request to an immediately lower level caching system, The lowest level caching system is an immediately lower level caching system than the highest level caching system. The lowest level caching system receives the second write request from the immediately higher level caching system. Finally, the lowest level caching system writes to the persistent memory system including at least the data including in the data write request.

The range of health may be used to configure the caching system, and may also be used to configure each level of a multi-level cache hierarchy. For example, the range of health may be used in determining whether the highest level caching system caches the data, acknowledges the data, or passes the data through. Each caching level in a multi-level cache hierarchy may be configured independently, or potentially as part of the caching system 110.

The diagnostic analysis may include a range of health for the computer system. This range of health may be used in determining whether the health of the computer system will support buffering at a given level in a multi-level caching system, or if the computer system will not support buffering at a given level. Each level in a multi-level caching system may be associated with a different caching state as described above, possibly including a write-through-buffer-noack state, a buffer-ack state, and a write-through-nobuffer-noack state. The range of health may include a level of write confidence associated the level of buffering. As described above, a write confidence may be a numerical value from 0 to N, where 0 represents an extremely low level of write confidence, such that a acknowledgment should be made from the persistent memory system 120. The value 1 may represent a slightly higher level of write confidence, such that only the sub-caching system closest to the persistent memory system should acknowledge the write request, such as 270-1. The value 2 may represent an additionally slightly higher level of write confidence, such that the sub-caching system 270-2 should acknowledge the write request. The highest level of health N, represent a highest level of write confidence, such that the sub-caching system 270-N may acknowledge the write request. Correspondingly, the diagnostic analysis may be used to configure the caching system and the persistent memory system.

The foregoing descriptions of specific embodiments and best mode of the present invention have been presented for purposes of illustration and description. They are not intended to be exhaustive or to limit the invention to the precise forms disclosed, and obviously many modifications and variations are possible in light of the above teaching. The embodiments were chosen and described to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method to maintain integrity of data written to a persistent memory system coupled with a computer system that can perform a data write request via a caching system with a buffer to said persistent memory system, the method comprising:
(A) performing a diagnostic analysis to determine if said computer system will support buffering said data in said caching system without loss of integrity;
(B) if step (a) is affirmative, configuring said caching system to buffer said data before writing to said persistent memory system; and
(C) if step (a) is negative, configuring said caching system to write-through said data to said persistent memory system.

2. The method of claim 1, wherein step (B) further includes buffering said data in said caching system, and further includes configuring said caching system to acknowledge said buffering to said computer system.

3. The method of claim 1, wherein step (C) further includes configuring said caching system to flush any contents of said buffer and write said contents to said persistent memory system.

4. The method of claim 1, wherein step (A) includes performing diagnostic analysis of systems coupled with said computer system including at least one of (a) any persistent memory, (b) ATA hard disk with SMART, (c) hard disk with self-diagnostic system, (d) battery backup, (e) operating system, and (f) ambient internal temperature.

5. The method of claim 1, wherein said caching system further includes a multi-level cache hierarchy system.

6. The method of claim 1, wherein said caching system includes a multi-level cache hierarchy system comprising:
at least two cache levels including:
a highest level sub-caching system to receive said data write request; and
a lowest level sub-caching system to write to said persistent memory system including at least said data included in said data write request,
wherein a higher level sub-caching system to send a second write request including at least said data included in said data write request to an immediately lower level sub-caching system, and a lower level sub-caching system to receive said second write request from an immediately higher level sub-caching system.

7. The method of claim 6, wherein said diagnostic analysis of step (A) includes a determining a range of health, and at least one of said configuring of steps (B) and (C) use said range of health to configure said at least two cache levels.

8. A method to maintain integrity of data written to a persistent memory system coupled with a computer system that can perform a data write request via a caching system to said persistent memory system, said computer system able to dynamically reconfigure said caching system and said persistent memory system as a function of a diagnostic analysis, where a successful data write request is signaled to said computer system by an acknowledgment signal, the method comprising the following steps:
(A) said computer system performs said data write request;
(B) said caching system receives said data write request, said caching system being state-configurable to include:
a write-through-buffer-noack state in which said data is buffered, without generating a cache acknowledgment signal; and
a buffer-ack state in which said data is buffered and said cache acknowledgment signal (C-ACK) is generated to acknowledge buffering of said data;
(C) said caching system performing a persistent data write request to store said data;
(D) said persistent memory system receiving and storing said data requested at step (C), said persistent memory system being state-configurable to include:
a memory-ack state in which said data is stored and a memory acknowledgment signal (M-ACK) is generated to acknowledge storing of said data, and
and a memory-noack state in which said data is stored without generating said memory acknowledgment signal;
(E) determining whether said C-ACK or said M-ACK was received by said computer system;
(F) if neither a C-ACK or a M-ACK was received, said computer system re-sending said data write request, if one of said C-ACK and said M-ACK was received, proceed to step (G);
(G) performing diagnostic analysis to determine if said computer system will support buffering said data in said caching system without loss of integrity; and
(H) dynamically configuring said caching system and said memory system based on diagnostic analysis performed at step (G), said configuration including at least one of (a) modifying cache state, and (b) modifying memory system state.

9. The method of claim 8, wherein step (B) further includes a write-through-nobuffer-noack state in which said data is passed through without buffering, and without generating said cache acknowledgment signal.

10. The method of claim 8, wherein step (H) includes configuring said caching system with said write-through-buffer-noack state if said computer system does not support acknowledging buffering said data in said caching system without loss of integrity, and configuring said caching system with said buffer-ack state if said computer system does will support buffering said data in said caching system without loss of integrity.

11. The method of claim 8, wherein step (B) includes providing a caching system that includes a multi-level cache hierarchy system.

12. The method of claim 8, wherein said caching system includes a multi-level cache hierarchy system.

13. The method of claim 8, wherein said step (G) further includes determining a range of health, wherein step (H) dynamically configuring said caching system and said memory system based on said range of health.

14. The method of claim 8, wherein
step (B) includes providing a multi-level cache hierarchy system comprising at least two cache levels including:
a highest level sub-caching system to receive said data write request of step (B); and
a lowest level sub-caching system to write to said persistent memory system including at least said data included in said data write request,
wherein a higher level sub-caching system to send a second write request including at least said data included in said data write request to an immediately lower level sub-caching system, and a lower level sub-caching system to receive said second write request from an immediately higher level sub-caching system; and
and step (C) is carried out by said lowest level sub-caching system.

15. The method of claim 14, wherein diagnostic analysis at step (G) includes a range of health, and dynamic configuration of step (H) uses said range of health to configure said at least two cache levels.

16. The method of claim 8, wherein diagnostic analysis at step (G) includes at least one of (a) persistent memory, (b) ATA hard disk with SMART, (c) hard disk with self-diagnostic system, (d) battery backup, (e) operating system, and (f) ambient internal temperature.

17. A system to maintain integrity of data written to a persistent memory system coupled with a computer system that can perform a data write request via a caching system to said persistent memory system, the system comprising:
a diagnostic system, coupled to said computer system, to perform a diagnostic analysis to determine if said computer system will support buffering said data in said caching system without loss of integrity;
a caching system, coupled to said diagnostic system and said computer system, to receive said data write request, to perform a persistent data write request to store said data, said caching system being state-configurable by said diagnostic system to include:
a write-through-buffer-noack state in which said data is buffered, without generating a cache acknowledgment signal; and
a buffer-ack state in which said data is buffered and said cache acknowledgment signal (C-ACK) is generated to acknowledge buffering of said data;
said persistent memory system, coupled to said diagnostic system and said computer system, to receive and to store said data.

18. The system of claim 17, wherein said caching system being state-configurable by said diagnostic system further includes a write-through-nobuffer-noack state in which said data is passed through without buffering, without generating said cache acknowledgment signal.

19. The system of claim 17, further including means for sending an acknowledgment to said computer system indicating a successful data write request.

20. The system of claim 17, further wherein at least one of said caching systems and said persistent memory system can issue an acknowledgment to said computer system indicating a successful data write request.

21. The system of claim 20, wherein said caching system includes a buffer-ack state in which said data of said data write request is buffered and a cache acknowledgment signal (C-ACK) is generated to acknowledge buffering of data; and
said persistent memory system being state-configurable to include a memory-ack state in which said data is stored and a memory acknowledgment signal (M-ACK) is generated to acknowledge storing of said data, and a memory-noack state in which said data is stored.

22. The system of claim 17, wherein said caching system is a multi-level cache hierarchy system.

23. The system of claim 17, wherein said caching system is a multi-level cache hierarchy system comprising:
at least two cache levels including:
a highest level sub-caching system to receive said data write request; and
a lowest level sub-caching system to write to said persistent memory system including at least said data included in said data write request,
wherein a higher level sub-caching system to send a second write request including at least said data included in said data write request to an immediately lower level sub-caching system and a lower level sub-caching system to receive said second write request from an immediately higher level sub-caching system.

24. The system of claim 23, wherein diagnostic system includes determining a range of health, and said dynamic configuration can utilize said range of health to configure said at least two cache level.

25. A dynamic cache control system to maintain integrity of data written to a persistent memory system coupled with a computer system that can perform a write data request via a caching system to said persistent memory means, the system comprising:
means for determining whether health of said computer system will support writing said data to said caching system without loss of integrity;
means for caching, coupled to said means for determining and said computer system, for receiving and buffering said write data request, said means for caching able to buffer said data before writing to said persistent memory means;
means for configuring, coupled to said means for caching and said computer system, said means for caching based on determination of health.

26. The system of claim 25, wherein said diagnosing means includes monitoring of at least one of (a) non-volatile memory, (b) ATA hard disk with SMART, (c) hard disk with self-diagnostic system, (d) battery backup, (e) operating system, and (f) ambient internal temperature.

27. The system of claim 25, wherein said caching means further includes a multi-level caching hierarchy means.

28. The method of claim 25, wherein said caching means includes a multi-level cache hierarchy means comprising:
at least two cache level means including a highest level sub-caching means to receive said write data request, to buffer, and to send a write request to an immediately lower level sub-caching means, and a lowest level sub-caching means to receive a write request from an immediately higher level sub-caching means, to buffer, and to write to said persistent memory means.

29. The method of claim 28, wherein said diagnosing means includes a range of health, and said configuration means can utilize said range of health to configure said at least two cache levels.
